(19) United States
(12) Patent Application Publication
(10) Pub. No.: US 2023/0120892 A1
(43) Pub. Date: Apr. 20, 2023

(54) VALVE DEVICE

(71) Applicant: DENSO CORPORATION, Kariya-city (JP)

(72) Inventors: Takehito MIZUNUMA, Kariya-city (JP); Shota KIMURA, Kariya-city (JP); Hiroki SHIMADA, Kariya-city (JP)

(21) Appl. No.: 18/083,672

(22) Filed: Dec. 19, 2022

Related U.S. Application Data
(63) Continuation of application No. PCT/JP2021/020414, filed on May 28, 2021.

(30) Foreign Application Priority Data
Jul. 3, 2020 (JP) 2020-115971

(51) Int. Cl. F16K 11/074

(52) U.S. Cl. CPC F16K 11/074

(57) ABSTRACT

In a valve device, a rotor has a hole closing portion configured to increase or decrease a covered area of a first flow hole of a stator in response to rotation of the rotor. The hole closing portion has a hole closing portion edge which extends in a radial direction of a predetermined axis and is located at a circumferential end of the hole closing portion on one side in a circumferential direction. In a state where the first flow hole is closed by the hole closing portion, when the rotor is rotated toward another side, which is opposite to the one side in the circumferential direction, the hole closing portion begins to open the first flow hole. The first flow hole has a one-side hole edge which is located at a circumferential end of the first flow hole on the one side and extends in the radial direction.

### CROSS REFERENCE TO RELATED APPLICATIONS

This application is a continuation application of International Patent Application No. PCT/JP2021/020414 filed on May 28, 2021, which designated the U.S. and claims the benefit of priority from Japanese Patent Application No. 2020-115971 filed on Jul. 3, 2020. The entire disclosures of all of the above applications are incorporated herein by reference.

### TECHNICAL FIELD

The present disclosure relates to a valve device configured to conduct fluid.

### BACKGROUND

Previously, there has been proposed a valve device that includes: a first valve plate, which is not rotatable; and a second valve plate, which is stacked over the first valve plate and is rotatable about a central axis.

The first valve plate has a first flow hole and a second flow hole, each of which is configured to conduct fluid, and the first flow hole and the second flow hole are arranged adjacent to each other in a circumferential direction of the central axis. The second plate is configured to open and close the first flow hole and the second flow hole in response to rotation of the second valve plate.

### SUMMARY

This section provides a general summary of the disclosure, and is not a comprehensive disclosure of its full scope or all of its features.

According to the present disclosure, there is provided a valve device configured to conduct fluid. The valve device includes: a rotor that is configured to rotate about a predetermined axis; and a flow hole formation portion that is located on one side of the rotor in an axial direction of the predetermined axis and has a flow hole which extends through the flow hole formation portion in the axial direction. The flow hole is configured to be opened and closed by the rotor and conduct the fluid through the flow hole in an open state where the flow hole is opened. The rotor has a hole closing portion that is configured to increase or decrease a covered area of the flow hole, which is covered by the hole closing portion, in response to rotation of the rotor.

In the valve device described above, in a view taken in the axial direction, a size of an opening area of an opened portion of the flow hole, which is opened by the hole closing portion, may linearly change in response to a change in a rotational angle of the rotor when the hole closing portion begins to open the flow hole from a state where the flow hole is entirely closed by the hole closing portion.

### BRIEF DESCRIPTION OF DRAWINGS

The drawings described herein are for illustrative purposes only of selected embodiments and not all possible implementations, and are not intended to limit the scope of the present disclosure.

FIG. 1 is a front view schematically showing a valve device of a first embodiment.

FIG. 2 is a plan view taken in a direction of an arrow II in FIG. 1, schematically showing the valve device of the first embodiment.

FIG. 3 is a cross-sectional view taken along line III-III in FIG. 2, schematically showing a cross section according to the first embodiment.

FIG. 4 is a cross-sectional view taken along line IV-IV in FIG. 3, schematically showing a cross section according to the first embodiment.

FIG. 5 is a cross-sectional view taken along line V-V in FIG. 4, schematically showing a cross section according to the first embodiment.

FIG. 6 is a cross-sectional view taken along line VI-VI in FIG. 3, schematically showing a cross section according to the first embodiment.

FIG. 7 is a cross-sectional view indicating the cross section of FIG. 6, from which a rotor and a valve rotatable shaft are omitted.

FIG. 8 is a cross-sectional view taken along line VIII-VIII in FIG. 4, schematically showing a cross section according to the first embodiment.

FIG. 9 is a diagram schematically indicating a drive force transmission path from an electric motor to the rotor according to the first embodiment.

FIG. 10 is a view taken in a direction of an arrow X in FIG. 9.

FIG. 11 is a cross-sectional view of a comparative example, corresponding to the cross section taken along lone VI-VI in FIG. 3.

FIG. 12 is a diagram indicating a relationship between a size of an opening area of a first flow hole and a rotational angle of a rotor in the comparative example.

FIG. 13 is a diagram indicating a relationship between a size of an opening area of a first flow hole and a rotational angle of the rotor in the first embodiment.

FIG. 14 is a diagram schematically indicating a drive force transmission path from an electric motor to a rotor according to a second embodiment.

FIG. 15 is a cross-sectional view showing a portion of a third embodiment corresponding to a portion XV shown in FIG. 3.

FIG. 16 is a cross-sectional view of a modification of the first embodiment, corresponding to FIG. 6 indicating a cross section taken along lone VI-VI in FIG. 3.

### DETAILED DESCRIPTION

Previously, there has been proposed a valve device that includes: a first valve plate, which is not rotatable; and a second valve plate, which is stacked over the first valve plate and is rotatable about a central axis.

The first valve plate has a first flow hole and a second flow hole, each of which is configured to conduct fluid, and the first flow hole and the second flow hole are arranged adjacent to each other in a circumferential direction of the central axis. The second plate is configured to open and close the first flow hole and the second flow hole in response to rotation of the second valve plate.

Furthermore, a hole edge of the first flow hole, which extends in a radial direction of the central axis and is located on a circumferential side that is adjacent to the second flow hole, and a hole edge of the second flow hole, which extends in the radial direction of the central axis and is located on a circumferential side that is adjacent to the first flow hole, are parallel to each other. Specifically, each of these hole edges does not intersect the central axis even when the hole edges are virtually extended in the radial direction.

Here, it is assumed that, for example, the first flow hole begins to open in response to rotation of the second valve plate, and a valve edge of the second valve plate, which extends in the radial direction, is placed over the hole edge of the first flow hole. In such a case, since the hole edge of the first flow hole and the hole edge of the second flow hole are parallel to each other, in a view taken in the axial direction of the central axis, the valve edge of the second valve plate is not placed in an orientation, in which the valve edge of the second valve plate extends along the hole edge of the first flow hole. Specifically, the valve edge of the second valve plate is placed in an orientation, in which the valve edge of the second valve plate intersects the hole edge of the first flow hole at a certain angle.

Therefore, in a case where a size of an opened portion of the first flow hole is increased or decreased by a minute opening degree of the first flow hole, the size of the opened portion is increased or decreased not only in the circumferential direction of the central axis but is also increased or decreased in the radial direction of the central axis in response to the rotation of the second valve plate. That is, the size of the opening area of the opened portion (i.e., a cross-sectional area of a passage) of the first flow hole is not changed in a simple manner relative to the rotational angle of the second valve plate. Therefore, the valve device of the patent literature 1 has the poor controllability at the time of attempting to control a minute flow rate of the fluid, which passes through the first flow hole, with high precision. As a result of the detailed study by the inventors of the present application, the above disadvantage is found.

According to one aspect of the present disclosure, there is provided a valve device configured to conduct fluid, including:
a rotor that is configured to rotate about a predetermined axis; and
a flow hole formation portion that is located on one side of the rotor in an axial direction of the predetermined axis and has:
   a first flow hole which extends through the flow hole formation portion in the axial direction, wherein the first flow hole is configured to be opened and closed by the rotor and conduct the fluid through the first flow hole in an open state where the first flow hole is opened; and
   a second flow hole which extends through the flow hole formation portion in the axial direction and is located adjacent to the first flow hole on one side of the first flow hole in a circumferential direction of the predetermined axis, wherein the second flow hole is configured to be opened and closed by the rotor and conduct the fluid through the second flow hole in an open state where the second flow hole is opened, wherein:
the rotor has a hole closing portion that is configured to increase or decrease a covered area of the first flow hole, which is covered by the hole closing portion, in response to rotation of the rotor;
the hole closing portion has a hole closing portion edge which extends in a radial direction of the predetermined axis and is located at a circumferential end of the hole closing portion on the one side in the circumferential direction, wherein in a state where the first flow hole is entirely closed by the hole closing portion, when the rotor is rotated toward another side, which is opposite to the one side in the circumferential direction, the hole closing portion begins to open the first flow hole;
the first flow hole has a one-side hole edge which is located at a circumferential end of the first flow hole on the one side in the circumferential direction and extends in the radial direction;
the second flow hole has an other-side hole edge which is located at a circumferential end of the second flow hole on the another side in the circumferential direction and extends in the radial direction;
in a view taken in the axial direction, the one-side hole edge and the other-side hole edge are symmetric to each other with respect to an imaginary inter-hole center line that extends in the radial direction from the predetermined axis and passes through a center that is centered between the one-side hole edge and the other-side hole edge; and
the one-side hole edge is progressively spaced from the imaginary inter-hole center line and thereby progressively increases a distance between the one-side hole edge and the imaginary inter-hole center line toward an outer side in the radial direction.

According to the above aspect, in the view taken in the axial direction, at the beginning of opening the first flow hole which has been entirely closed, in comparison to the case where the one-side hole edge of the first flow hole and the other-side hole edge of the second flow hole are parallel to each other, the one-side hole edge of the first flow hole is placed close to the orientation, in which the one-side hole edge of the first flow hole extends along the hole closing portion edge. Therefore, since the size of the opening area of the first flow hole changes in a nearly linear manner from the beginning of the opening of the first flow hole relative to the rotational angle of the rotor, it is possible to improve the controllability in the control of the minute flow rate of the fluid passing through the first flow hole.

Furthermore, according to another aspect of the present disclosure, there is provided a valve device configured to conduct fluid, including:
a rotor that is configured to rotate about a predetermined axis; and
a flow hole formation portion that is located on one side of the rotor in an axial direction of the predetermined axis and has a flow hole which extends through the flow hole formation portion in the axial direction, wherein the flow hole is configured to be opened and closed by the rotor and conduct the fluid through the flow hole in an open state where the flow hole is opened, wherein:
the rotor has a hole closing portion that is configured to increase or decrease a covered area of the flow hole, which is covered by the hole closing portion, in response to rotation of the rotor; and
in a view taken in the axial direction, a size of an opening area of an opened portion of the flow hole, which is opened by the hole closing portion, linearly changes in response to a change in a rotational angle of the rotor when the hole closing portion begins to open the flow hole from a state where the flow hole is entirely closed by the hole closing portion.

Therefore, in comparison to the case, in which the size of the opening area of the flow hole changes in a non-linear manner from the beginning of the opening of the flow hole relative to the rotational angle of the rotor, it is possible to improve the controllability in the control of the minute flow rate of the fluid passing through the flow hole.

Hereinafter, each of embodiments will be described with reference to the drawings. In each of the following embodiments, portions, which are the same or equivalent to each other, will be indicated by the same reference signs.

### First Embodiment

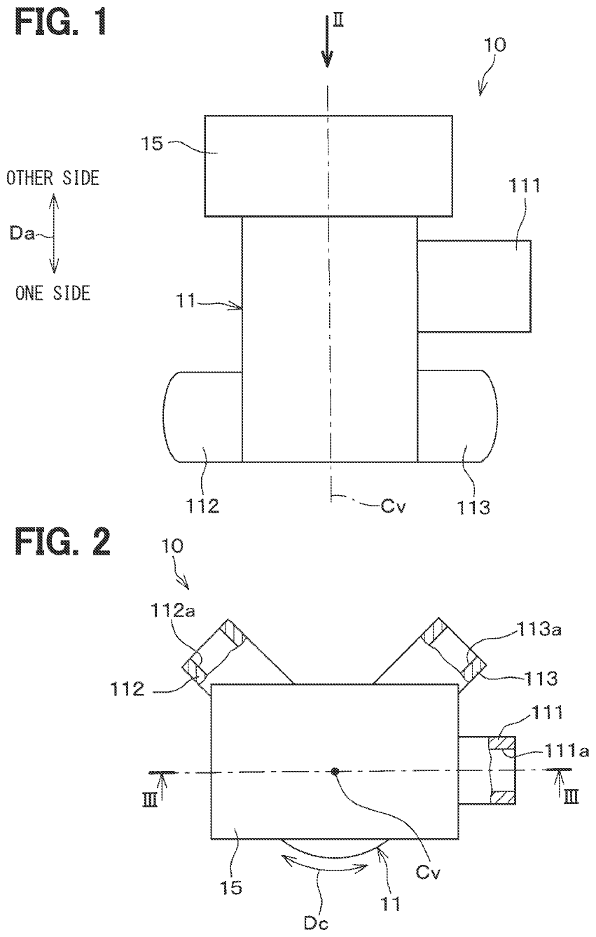

A valve device 10 of the present embodiment is a coolant control valve for a vehicle installed at, for example, a hybrid vehicle. The valve device 10 shown in FIGS. 1 and 2 is a constituent of a coolant circuit that circulates coolant through a vehicle drive power source, a radiator and a heater core (a heat exchanger for air conditioning). Therefore, the coolant, which is circulated through the coolant circuit, flows through the valve device 10.

The valve device 10 can increase or decrease a flow rate of the coolant in the flow path through the valve device 10 in the coolant circuit, and the valve device 10 can also switch or shut off the flow path. The coolant is a fluid (more specifically, a liquid) , and, for example, LLC (Long Life Coolant) containing ethylene glycol is used as the coolant.

Specifically, as shown in FIGS. 1 to 3, the valve device 10 is a disc valve that performs a valve opening/closing operation by rotating a rotor 16, which is shaped generally in a form of a circular disk, around a valve axis Cv that serves as a predetermined axis. The valve device 10 is a three-way valve and includes an inlet port 111, a first outlet port 112 and a second outlet port 113. The valve device 10 adjusts a flow rate ratio between: a flow rate of the coolant which flows from the inlet port 111 to the first outlet port 112; and a flow rate of the coolant which flows from the inlet port 111 to the second outlet port 113.

In the description of the present embodiment, an axial direction of the valve axis Cv is also referred to as a valve axial direction Da, and a radial direction of the valve axis Cv is also referred to as a valve radial direction Dr. Furthermore, a circumferential direction about the valve axis Cv is also referred to as a valve circumferential direction Dc.

The valve device 10 includes a housing 11, a stator 12, an electric motor 13, a gear mechanism 14, the rotor 16 and a valve rotatable shaft (serving as an interposed body) 1 7.

The housing 11 is a valve housing that forms an outer shell of the valve device 10. The housing 11 is a non-rotating member that does not rotate, and the housing 11 is made of, for example, resin. The housing 11 receives the stator 1 2, the rotor 16 and the valve rotatable shaft 17 at an inside of the housing 11. The housing 11 also has: the inlet port 111 which forms a coolant inlet 111a, the first outlet port 112, which forms a first outlet 112a; and the second outlet port 113, which forms a second outlet 113a.

Each of the inlet port 111, the first outlet port 112 and the second outlet port 113 is shaped in a tubular form and projects outward in the valve radial direction Dr. Furthermore, the first outlet port 112 and the second outlet port 113 are arranged one after another in the valve circumferential direction Dc and are located on one side of the inlet port 111 in the valve axial direction Da.

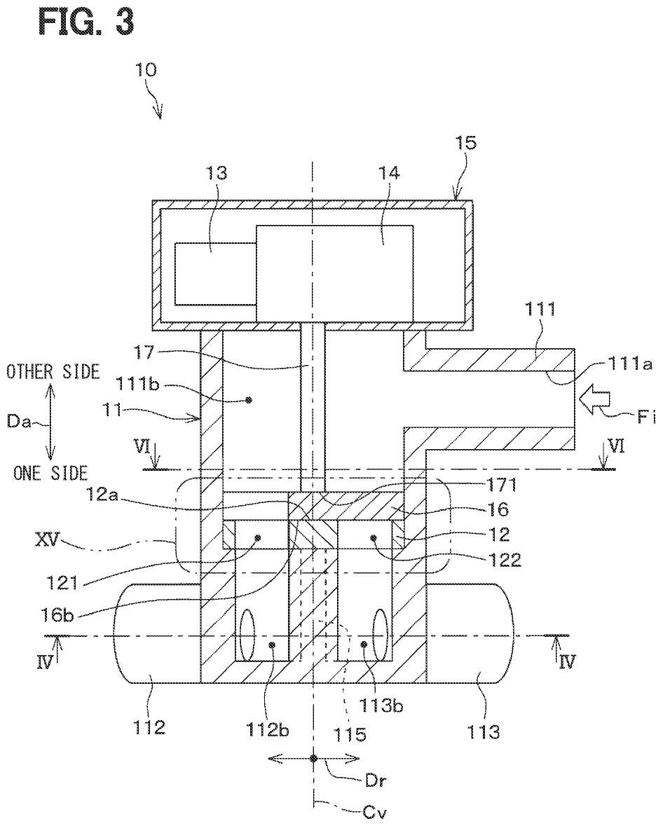

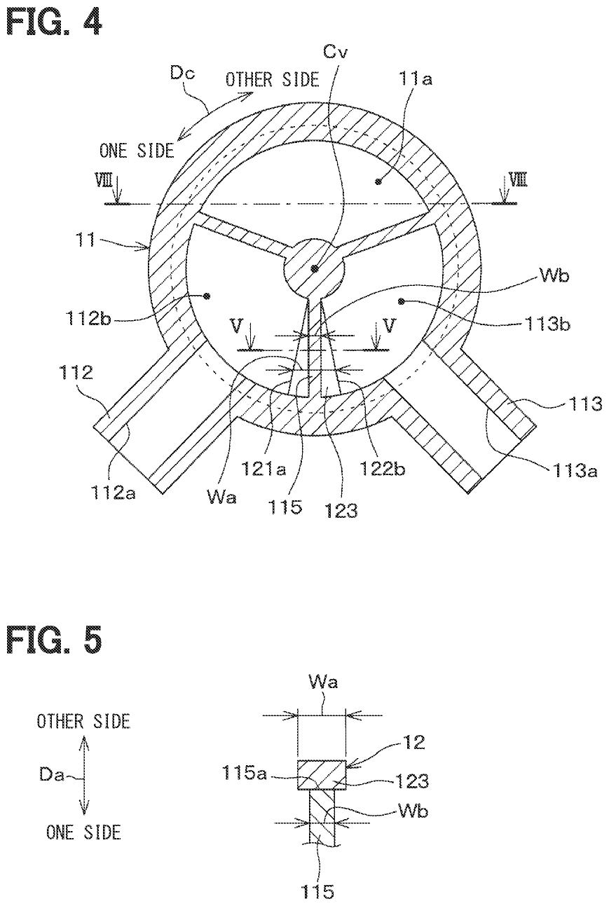

As shown in FIGS. 3 and 4, the inside of the housing 11 is partitioned into a plurality of spaces 111b, 112b, 113b. Specifically, the inside of the housing 11 is partitioned into: an inlet communication chamber 111b which is communicated with the coolant inlet 111a, a first communication chamber 112b which is communicated with the first outlet 112a; and a second communication chamber 113b which is communicated with the second outlet 11 3a. The housing 11 has an outlet-side partition 115 which is formed at the inside of the housing 11.

The outlet-side partition 115 is shaped in a plate form that has a thickness direction which is perpendicular to the valve axial direction Da. The outlet-side partition 115 is a partition wall that partitions between the first communication chamber 112b and the second communication chamber 113b. Therefore, the first communication chamber 112b is placed on one side of the outlet-side partition 115 in a thickness direction of the outlet-side partition 115, and the second communication chamber 113b is placed on another side of the outlet-side partition 115 in the thickness direction of the outlet-side partition 115.

The stator 12 is shaped in a plate form that has a thickness direction which coincides with the valve axial direction Da, and the stator 12 is made of, for example, resin that exhibits high sliding performance. The stator 12 is installed at an inside of the housing 11 such that the stator 12 is non-rotatable relative to the housing 11 through engagement between a recess and projection (not shown) while one of the recess and the projection is formed at the stator 12, and the other one of the recess and the projection is formed at the housing 11.

In the housing 11, the stator 12 partitions between the inlet communication chamber 111b and the first communication chamber 112b and also partitions between the inlet communication chamber 111b and the second communication chamber 113b. Therefore, the first communication chamber 112b and the second communication chamber 113b are placed on the one side of the stator 12 in the valve axial direction Da, and the inlet communication chamber 111b is placed on the other side of the stator 12 in the valve axial direction Da.

As shown in FIGS. 3 to 5, the outlet-side partition 115 is placed on the one side of the stator 12 in the valve axial direction Da. The outlet-side partition 115 has a contact end part 11 5a at an end of the outlet-side partition 115 on the other side in the valve axial direction Da, and the contact end part 115a contacts the stator 12.

As shown in FIGS. 3, 6 and 7, the stator 12 is formed as a flow hole formation portion and has a first and second flow holes 121, 1 22 through which the coolant is conducted in the housing 11. Each of the first and second flow holes 121, 122 is formed as a through-hole that extends through the stator 12 in the valve axial direction Da. The first flow hole 121 is formed between the inlet communication chamber 111b and the first communication chamber 112b to communicate between the inlet communication chamber 111b and the first communication chamber 112b. The second flow hole 122 is formed between the inlet communication chamber 111b and the second communication chamber 113b to communicate between the inlet communication chamber 111 b and the second communication chamber 113b.

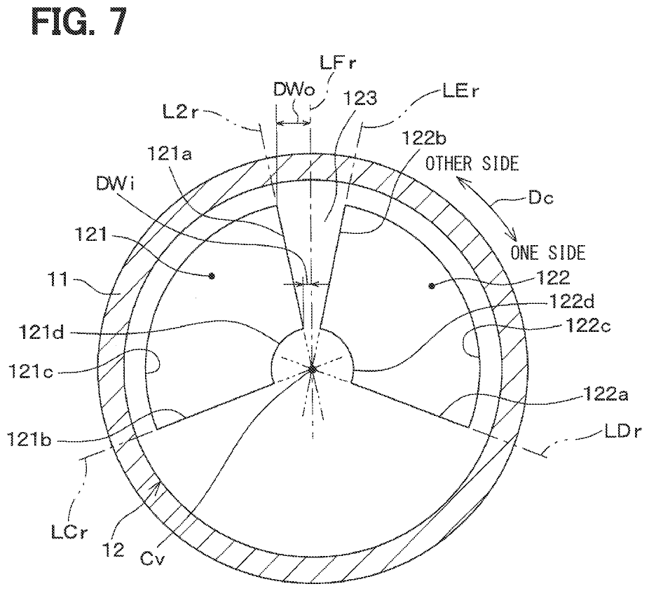

Furthermore, as shown in FIG. 7, the second flow hole 122 is located adjacent to the first flow hole 121 on one side of the first flow hole 121 in the valve circumferential direction Dc. Since the first flow hole 121 and the second flow hole 122 are arranged one after another in the valve circumferential direction Dc, one circumferential interval between the first flow hole 121 and the second flow hole 122 is provided on the one side of the first flow hole 121 in the valve circumferential direction Dc, and another circumferential interval between the first flow hole 121 and the second flow hole 122 is provided on the other side of the first flow hole 121 in the valve circumferential direction Dc. However, the one circumferential interval (in other words, a circumferential width of a flow hole partition 123), which is located on the one side of the first flow hole 121 in the valve circumferential direction Dc, is much smaller than the other circumferential interval, which is located on the other side of the first flow hole 121 in the valve circumferential direction Dc. Therefore, the second flow hole 122 is not adjacent to the first flow hole 121 on the other side of the first flow hole 121 in the valve circumferential direction Dc but is adjacent to the first flow hole 121 on the one side of the first flow hole 121 in the valve circumferential direction Dc.

Furthermore, as shown in FIG. 7, the stator 12 has the flow hole partition 123 that partitions between the first flow hole 121 and the second flow hole 122. This flow hole partition 123 borders the first flow hole 121 on the one side of the first flow hole 121 in the valve circumferential direction Dc, and the flow hole partition 123 borders the second flow hole 122 on the other side of the second flow hole 122 in the valve circumferential direction Dc.

Furthermore, as shown in FIG. 5, the contact end part 115a of the outlet-side partition 115 contacts the flow hole partition 123 from the one side in the valve axial direction Da. Furthermore, the rotor 16 is urged against the stator 12 in the valve axial direction Da by, for example, a spring mechanism (not shown), so that the flow hole partition 123 is urged against the contact end part 115a of the outlet-side partition 115.

As shown in FIGS. 4, 5 and 7, the flow hole partition 123 is shaped such that a width of the flow hole partition 123 progressively increases toward an outer side in the valve radial direction Dr, and thereby the flow hole partition 123 has a widened part that has the width which is measured in the valve circumferential direction Dc and is larger than the width of the contact end part 115a measured in the valve circumferential direction Dc. For example, as shown in FIG. 5, a size relationship between the width Wa of the widened part of the flow hole partition 123 and the width Wb of the contact end part 115a is Wa>Wb. Furthermore, a narrowest part of the flow hole partition 123 has the smallest width in the valve circumferential direction Dc at the flow hole partition 123, and this width of the narrowest part is equal to or slightly larger than the width Wb of the contact end part 115a.

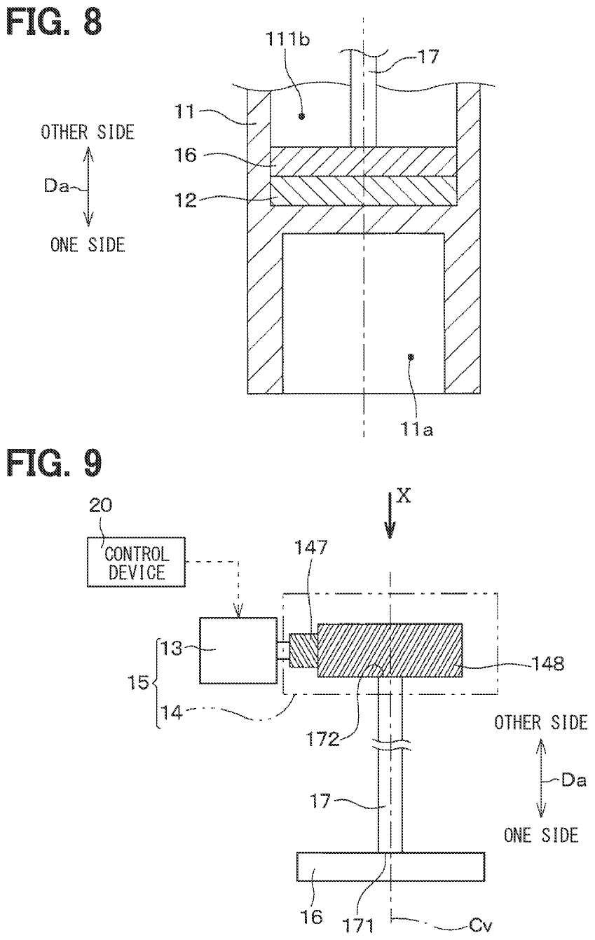

As shown in FIGS. 4 and 8, a non-circulating space 11a is formed in the housing 11. The non-circulating space 11a is a dead space, through which the coolant does not flow. This non-circulating space 11a is isolated from all of the communication chambers 111b, 112b, 113b by partition walls in the housing 11. The non-circulating space 11a is located on the one side of the stator 12 in the valve axial direction Da, and the non-circulating space 11a and the first and second communication chambers 112b, 113b are circumferentially arranged one after another. By forming this non-circulating space 11 a in the housing 11, the first and second communication chambers 112b, 113b do not become unnecessarily larger with respect to the first and second flow holes 121, 122.

As shown in FIGS. 3 and 9, the electric motor 13 is a drive source that is rotated when it is energized. The electric motor 13 is rotated according to a control signal outputted from a control device 20 that is electrically connected to the electric motor 13.

Furthermore, the electric motor 13 of the present embodiment is a stepping motor. Therefore, since the rotational angle of the electric motor 13 can be controlled by the function of the stepping motor, a rotational position of the rotor 16, which is driven by the electric motor 13, can be uniquely determined, and thereby it is not necessary to provide a rotational angle sensing function separately from the electric motor 13.

The control device 20 is a computer that has a non-transitory tangible storage medium (e.g., a semiconductor memory), a processor and the like and executes a computer program stored in the non-transitory tangible storage medium. When this computer program is executed, a method, which corresponds to the computer program, is executed. That is, the control device 20 executes various control processes according to its computer program.

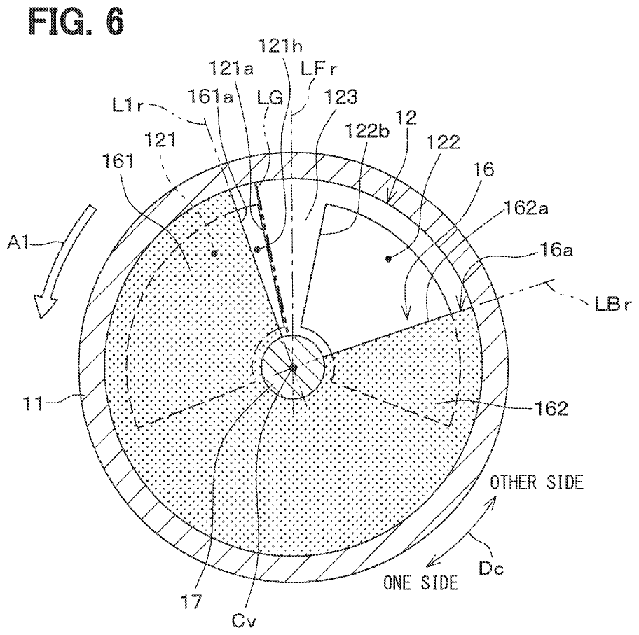

As shown in FIGS. 3 and 6, the rotor 16 is configured to rotate about the valve axis Cv. Specifically, the rotor 16 is configured to rotate about the valve axis Cv relative to the housing 11 and the stator 12. In FIG. 6 and other corresponding drawings, which correspond to FIG. 6, the rotor 16 is indicated with a dotted hatching pattern to better illustrate the rotor 16.

The rotor 16 is a valve element that increases or decreases an opening degree of the first flow hole 121 and an opening degree of the second flow hole 122 in response to the rotation of the rotor 16. In short, the rotor 16 is the valve element that is rotated about the valve axis Cv. Therefore, each of the first and second flow holes 121, 122 is configured to be opened and closed by the rotor 16 and conduct the coolant therethrough in an open state where the flow hole 121, 122 is opened.

The rotor 16 is shaped in the form of the circular disk that is partially cutout while a thickness direction of the rotor 16 coincides with the valve axial direction Da, and the rotor 16 is made of resin that exhibits high sliding performance. The rotor 16 is located on the other side of the stator 12 in the valve axial direction Da and is stacked over the stator 12. In short, the rotor 16 is located in the inlet communication chamber 111b. Therefore, although an end of each of the first and second flow holes 121, 122, which is located on the inlet communication chamber 111b side, may be closed by the rotor 16 depending on the rotational position of the rotor 16, the first flow hole 121 and the second flow hole 122 are communicated with the first communication chamber 112b and the second communication chamber 113b, respectively, regardless of the rotation of the rotor 16.

The opening degree of the first flow hole 121 is a degree of opening of the first flow hole 121. Here, the opening degree of the first flow hole 121 in a full-opening state thereof is indicated as 100%, and the opening degree of the first flow hole 121 in a full-closing state thereof is indicated as 0%. The full-opening state of the first flow hole 121 is a state where the first flow hole 121 is not closed at all by the rotor 16, and a full-closing state of the first flow hole 121 is a state where the first flow hole 121 is entirely closed by the rotor 16. The above description about the first flow hole 121 is also equally applicable to the opening degree of the second flow hole 122.

As shown in FIG. 6, the rotor 16 has a first hole closing portion 161, which is configured to cover and close the first flow hole 121, and a second hole closing portion 162, which is configured to cover and close the second flow hole 122. In other words, the first hole closing portion 161 is a portion of the rotor 16 that covers the first flow hole 121 when the first flow hole 121 is in the full-closing state, and the second hole closing portion 162 is a portion of the rotor 16 that covers the second flow hole 122 when the second flow hole 122 is in the full-closing state.

Therefore, the first hole closing portion 161 is configured to increase or decrease a covered area of the first flow hole 121, which is covered by the first hole closing portion 161, in response to the rotation of the rotor 16. The second hole closing portion 162 is configured to increase or decrease a covered area of the second flow hole 122, which is covered by the second hole closing portion 162, in response to the rotation of the rotor 16.

In a view taken in the valve axial direction Da shown in FIG. 6, the rotor 16 has a cutout 16a, which is shaped in a V-shape, and the first hole closing portion 161 is located adjacent to the cutout 16a on the other side in the valve circumferential direction Dc. Therefore, the first hole closing portion 161 has a first hole closing portion edge 161a which extends in the valve radial direction L1r and is located at a circumferential end of the first hole closing portion 161 on the one side in the valve circumferential direction Dc. The first hole closing portion edge 161a extends in the valve radial direction L1r along an imaginary first radial line L1r which linearly extends from the valve axis Cv in the radial direction.

Furthermore, in the view taken in the valve axial direction Da, the second hole closing portion 162 is located adjacent to the cutout 16a, which is shaped in the V-shape, on the one side in the valve circumferential direction Dc. Therefore, the second hole closing portion 162 has a second hole closing portion edge 162a which extends in the valve radial direction L1r and is located at a circumferential end of the second hole closing portion 162 on the other side in the valve circumferential direction Dc. The second hole closing portion edge 162a extends in the valve radial direction Dr along an imaginary radial line LBr which linearly extends from the valve axis Cv in the radial direction L1r and intersects the first radial line L1r.

Furthermore, the rotor 16 is configured to be rotated such that when the opening degree of the first flow hole 121 is increased, the opening degree of the second flow hole 122 is decreased. FIG. 6 shows a state in which the first flow hole 121 is slightly opened from the full-closing state, so that the first flow hole 121 has a minute opening degree, and the second flow hole 122 has an opening degree of 50% or more.

Furthermore, as shown in FIGS. 3 and 6, the rotor 16 has a rotor-side seal surface 16b which faces the one side in the valve axial direction Da. Also, the stator 12 has a stator-side seal surface 12a which is opposed to the rotor-side seal surface 16b in the valve axial direction Da. The stator-side seal surface 12a slidably contacts the rotor-side seal surface 16b. The rotor-side seal surface 16b is urged against the stator-side seal surface 12a by, for example, the spring mechanism (not shown), so that the rotor-side seal surface 16b and the stator-side seal surface 12a limit leakage of the coolant that flows between the seal surfaces 16b, 12a.

The valve rotatable shaft 17 is a rotatable shaft that extends in the valve axial direction Da and is configured to rotate about the valve axis Cv. Specifically, the valve rotatable shaft 17 is configured to rotate about the valve axis Cv relative to the housing 11 and the stator 12.

The valve rotatable shaft 17 has one end part 171 on the one side in the valve axial direction Da and the other end part 172 on the other side in the valve axial direction Da (see FIG. 9). The one end part 171 of the valve rotatable shaft 17 is securely coupled to the rotor 16. Specifically, the valve rotatable shaft 17 is configured to be rotated integrally with the rotor 16. The other end part 172 of the valve rotatable shaft 17 is coupled to the gear mechanism 14. Therefore, the valve rotatable shaft 17 extends through the inlet communication chamber 111 b and is coupled to the rotor 16 to transmit the rotation between the gear mechanism 14 and the rotor 16. The rotor 16 and the valve rotatable shaft 17 are configured to be rotated by the rotation of the electric motor 13.

As shown in FIGS. 3, 9 and 10, the electric motor 13 and the gear mechanism 14 form a drive unit 15 which is configured to rotate the rotor 16. The drive unit 15 is located on the other side of the housing 11 in the valve axial direction Da.

The gear mechanism 14 includes a plurality of gears 147, 148. In the gear mechanism 14, the gears 147, 148 are meshed with each other to transmit the rotation of the electric motor 13 to the rotor 16 and thereby rotate the rotor 16.

Specifically, the gears 147, 148 of the gear mechanism 14 of the present embodiment include: a worm 147 which has a spiral tooth; and a worm wheel 148 which is meshed with the worm 147. That is, the gear mechanism 14 of the present embodiment is a worm gear mechanism.

The worm 147 of the gear mechanism 14 is securely coupled to the rotatable shaft of the electric motor 13, and the worm wheel 148 is securely coupled to the other end part 172 of the valve rotatable shaft 17. Therefore, when the electric motor 13 generates the rotational force, the rotational force of the electric motor 13 is transmitted to the rotor 16 through the worm 147, the worm wheel 148 and the valve rotatable shaft 17.

Furthermore, the worm 147 cannot be rotated by the worm wheel 148. That is, the worm 147 is configured to limit transmission of the rotational force from the worm wheel 148 to the electric motor 13.

Now, a shape of the first flow hole 121 shown in FIG. 7 will be described. In the view taken in the valve axial direction Da, the first flow hole 121 has a one-side hole edge 121a, an other-side hole edge 121b, a radially outer hole edge 121c and a radially inner hole edge 121d. That is, the peripheral edge (the outline) of the first flow hole 121 is formed by the one-side hole edge 121a, the other-side hole edge 121b, the radially outer hole edge 121c and the radially inner hole edge 121d.

The one-side hole edge 121a of the first flow hole 121 is located at a circumferential end of the first flow hole 121 on the one side in the valve circumferential direction Dc and extends in the valve radial direction Dr. Specifically, the one-side hole edge 121a extends in the valve radial direction L1r along an imaginary second radial line L2r which linearly extends from the valve axis Cv in the valve radial direction Dr. Furthermore, since the one-side hole edge 121a of the first flow hole 121 is formed by the flow hole partition 123 of the stator 12, the first flow hole 121 borders the flow hole partition 123 of the stator 12 through the one-side hole edge 121a.

The other-side hole edge 121b of the first flow hole 121 is located at another circumferential end of the first flow hole 121 on the other side in the valve circumferential direction Dc and extends in the valve radial direction Dr. Specifically, the other-side hole edge 121b extends in the valve radial direction L1r along an imaginary radial line LCr which linearly extends from the valve axis Cv in the valve radial direction Dr.

Each of the radially outer hole edge 121c and the radially inner hole edge 121d of the first flow hole 121 arcuately extends about the valve axis Cv in the valve circumferential direction Dc. Therefore, a radial interval between the radially outer hole edge 121c and the radially inner hole edge 121d, i.e., a radial width of the first flow hole 121 is constant.

The radially outer hole edge 121c of the first flow hole 121 is located at an outer radial end of the first flow hole 121 located on the outer side in the valve radial direction L1r and connects between an outer radial end of the one-side hole edge 121a and an outer radial end of the other-side hole edge 121b at the first flow hole 121. The radially inner hole edge 121d of the first flow hole 121 is located at an inner radial end of the first flow hole 121 located on the inner side in the valve radial direction L1r and connects between an inner radial end of the one-side hole edge 121a and an inner radial end of the other-side hole edge 121 b at the first flow hole 121.

Next, a shape of the second flow hole 122 will be described. In the view taken in the valve axial direction Da, the second flow hole 122 is line symmetric with the first flow hole 121. Therefore, like the first flow hole 121, the second flow hole 122 has a one-side hole edge 122a, an other-side hole edge 122b, a radially outer hole edge 122c and a radially inner hole edge 122d. That is, the peripheral edge (the outline) of the second flow hole 122 is formed by the one-side hole edge 122a, the other-side hole edge 122b, the radially outer hole edge 122c and the radially inner hole edge 122d.

The one-side hole edge 122a of the second flow hole 122 is located at a circumferential end of the second flow hole 122 on the one side in the valve circumferential direction Dc and extends in the valve radial direction Dr. Specifically, the one-side hole edge 122a extends in the valve radial direction L1r along an imaginary radial line LDr which linearly extends from the valve axis Cv in the valve radial direction Dr.

The other-side hole edge 122b of the second flow hole 122 is located at another circumferential end of the second flow hole 122 on the other side in the valve circumferential direction Dc and extends in the valve radial direction Dr. Specifically, the other-side hole edge 122b extends in the valve radial direction L1r along an imaginary radial line LEr which linearly extends from the valve axis Cv in the valve radial direction Dr. Furthermore, since the other-side hole edge 122b of the second flow hole 122 is formed by the flow hole partition 123 of the stator 12, the second flow hole 122 borders the flow hole partition 123 of the stator 12 through the other-side hole edge 122b. The four radial lines L2r, LCr, LDr, LEr described above are different from each other and intersect with each other.

Each of the radially outer hole edge 122c and the radially inner hole edge 122d of the second flow hole 122 arcuately extends about the valve axis Cv in the valve circumferential direction Dc. Therefore, a radial interval between the radially outer hole edge 122c and the radially inner hole edge 122d, i.e., a radial width of the second flow hole 122 is constant.

The radially outer hole edge 122c of the second flow hole 122 is located at an outer radial end of the second flow hole 122 located on the outer side in the valve radial direction L1r and connects between an outer radial end of the one-side hole edge 122a and an outer radial end of the other-side hole edge 122b. The radially inner hole edge 122d of the second flow hole 122 is located at an inner radial end of the second flow hole 122 located on the inner side in the valve radial direction L1r and connects between an inner radial end of the one-side hole edge 122a and an inner radial end of the other-side hole edge 122b at the second flow hole 122.

The first and second flow holes 121,122 are formed in the above-described manner. Therefore, as shown in FIG. 7, in the view taken in the valve axial direction Da, the one-side hole edge 121a of the first flow hole 121 and the other-side hole edge 122b of the second flow hole 122 are symmetric to each other with respect to an imaginary inter-hole center line LFr. The inter-hole center line LFr is a center line that linearly extends in the valve radial direction L1r from the valve axis Cv and passes through a center that is centered between the one-side hole edge 121a of the first flow hole 121 and the other-side hole edge 122b of the second flow hole 122.

The one-side hole edge 121a of the first flow hole 121 is progressively spaced from the inter-hole center line LFr toward the other side in the valve circumferential direction Dc and thereby progressively increases a distance between the one-side hole edge 121a of the first flow hole 121 and the inter-hole center line LFr toward the outer side in the valve radial direction Dr. For example, an interval DWo between the outer radial end of the one-side hole edge 121a, which is located on the outer side in the valve radial direction Dr, and the inter-hole center line LFr, is larger than an interval DWi between the inner radial end of the one-side hole edge 121a, which is located on the inner side in the valve radial direction Dr, and the inter-hole center line LFr.

In contrast, the other-side hole edge 122b of the second flow hole 122 is progressively spaced from the inter-hole center line LFr toward the one side in the valve circumferential direction Dc and thereby progressively increases a distance between the other-side hole edge 122b of the second flow hole 122 and the inter-hole center line LFr toward the outer side in the valve radial direction Dr.

In the valve device 10 formed in the above-described manner, as shown in FIG. 3, the coolant flows from the coolant inlet 111a into the inlet communication chamber 111b as indicated by an arrow Fi. Then, in the state where the first flow hole 121 is opened, the coolant in the inlet communication chamber 111b flows from the inlet communication chamber 111b to the first communication chamber 112b through the first flow hole 121. The coolant in the first communication chamber 112b flows from the first communication chamber 112b to the outside of the valve device 10 through the first outlet 112a.

In this case, as shown in FIGS. 3 and 6, the flow rate of the coolant, which passes through the first flow hole 121, is determined according to the opening degree of the first flow hole 121. That is, the flow rate of the coolant, which flows from the coolant inlet 111a to the first outlet 112a through the first flow hole 121, is increased when the opening degree of the first flow hole 121 is increased.

For example, at the time of adjusting the opening degree of the first flow hole 121, in the state where the first flow hole 121 is entirely closed by the rotor 16, when the rotor 16 is rotated as indicated by an arrow A1, the rotor 16 begins to open the first flow hole 121. That is, when the rotor 16 is rotated toward the other side in the valve circumferential direction Dc, the first hole closing portion 161 of the rotor 16 begins to open the first flow hole 121 which has been entirely closed.

In contrast, in the state where the second flow hole 122 is opened, the coolant in the inlet communication chamber 111 b flows from the inlet communication chamber 111b to the second communication chamber 113b through the second flow hole 122. The coolant in the second communication chamber 113b flows from the second communication chamber 113b to the outside of the valve device 10 through the second outlet 113a.

In this case, the flow rate of the coolant, which passes through the second flow hole 122, is determined according to the opening degree of the second flow hole 122. That is, the flow rate of the coolant, which flows from the coolant inlet 111a to the second outlet 113a through the second flow hole 122, is increased when the opening degree of the second flow hole 122 is increased.

For example, at the time of adjusting the opening degree of the second flow hole 122, in the state where the second flow hole 122 is entirely closed by the rotor 16, when the rotor 16 is rotated in the direction opposite to the arrow A1, the rotor 16 begins to open the second flow hole 122. That is, when the rotor 16 is rotated toward the one side in the valve circumferential direction Dc, the second hole closing portion 162 of the rotor 16 begins to open the second flow hole 122 which has been entirely closed.

Now, a valve device 80 of a comparative example, which is comparative to the valve device 10 of the present embodiment, will be described. In the valve device 80 of the comparative example shown in FIG. 11, an extending direction of a one-side hole edge 821a, 822a and an extending direction of an other-side hole edge 821b, 822b of each of first and second flow holes 821, 822 are slightly different from those of the valve device 10 of the present embodiment. Other than this point, the valve device 80 of the comparative example is the same as the valve device 10 of the present embodiment.

As shown in FIGS. 6, 7 and 11, a stator 82 of the comparative example corresponds to the stator 12 of the present embodiment, and the first flow hole 821 of the comparative example corresponds to the first flow hole 121 of the present embodiment. Furthermore, the second flow hole 822 of the comparative example corresponds to the second flow hole 122 of the present embodiment. Furthermore, the one-side hole edge 821a of the first flow hole 821 of the comparative example corresponds to the one-side hole edge 121a of the first flow hole 121, and the other-side hole edge 821b of the first flow hole 821 of the comparative example corresponds to the other-side hole edge 121b of the first flow hole 121 of the present embodiment. Also, the one-side hole edge 822a of the second flow hole 822 of the comparative example corresponds to the one-side hole edge 122a of the second flow hole 122, and the other-side hole edge 822b of the second flow hole 822 of the comparative example corresponds to the other-side hole edge 122b of the second flow hole 122 of the present embodiment. Furthermore, a flow hole partition 823 of the comparative example corresponds to the flow hole partition 123 of the present embodiment. In the following description of the comparative example, the differences between the comparative example and the present embodiment will be mainly explained under the above-described relationships.

Specifically, as shown in FIG. 11, in the comparative example, each of the one-side hole edge 821a, 822a and the other-side hole edge 821 b, 822b of each of the first and second flow holes 821, 822 does not extend along a radial line that linearly extends from the valve axis Cv in the valve radial direction Dr. For example, the one-side hole edge 821a of the first flow hole 821 and the other-side hole edge 822b of the second flow hole 822 extend parallel with the inter-hole center line LFr that is centered between the one-side hole edge 821a of the first flow hole 821 and the other-side hole edge 822b of the second flow hole 822.

Therefore, in the comparative example, when the rotor 16 begins to open the first flow hole 821, which has been entirely closed, to place the first hole closing portion edge 161a to a position where the first hole closing portion edge 161a overlaps with the one-side hole edge 821a of the first flow hole 821 on the other side in the valve axial direction Da, the first hole closing portion edge 161a and the one-side hole edge 821a have a positional relationship shown in FIG. 11. That is, in the view taken in the valve axial direction Da, the first hole closing portion edge 161a is not placed in an orientation, in which the first hole closing portion edge 161a extends along the one-side hole edge 821a of the first flow hole 821, but the first hole closing portion edge 161a is placed in an orientation, in which the first hole closing portion edge 161a crosses the one-side hole edge 821a.

Therefore, in the case where a size of an opened portion 821 h of the first flow hole 821 is increased or decreased by a minute opening degree of the first flow hole 821, the size of the opened portion 821h is increased or decreased not only in the valve circumferential direction Dc but is increased or decreased also in the valve radial direction L1r in response to the rotation of the rotor 16. For example, a radial length Lr of the opened portion 821h of the first flow hole 821 measured in the valve radial direction L1r is also increased or decreased in response to the rotation of the rotor 16.

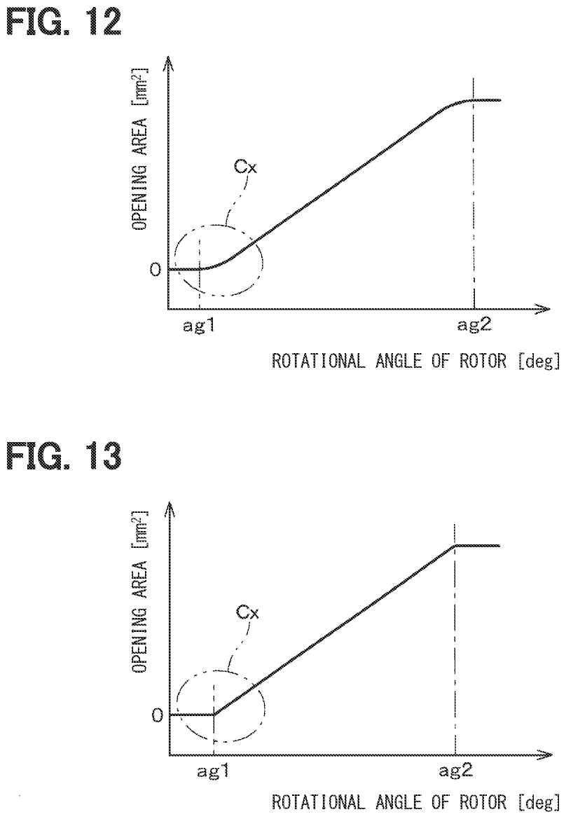

Therefore, in the comparative example, in the case where the rotor 16 is rotated toward the other side in the valve circumferential direction Dc as indicated by the arrow A1, the size of the opening area of the first flow hole 821 changes relative to the rotational angle of the rotor 16 as shown in FIG. 12. That is, as encircled by a dot-dot-dash line Cx in FIG. 12, at the minute opening degree during the beginning of the opening of the first flow hole 821, the relationship between the size of the opening area of the first flow hole 821 and the rotational angle of the rotor 16 is not linear. Specifically, in the view taken in the valve axial direction Da, the opening area of the first flow hole 821 is an area of the opened portion (i.e., the opened portion 821h of FIG. 11) of the first flow hole 821, which is opened by the first hole closing portion 161.

A rotational angle ag1 shown in FIG. 12 and FIG. 13 described later is a rotational angle of the rotor 16 when the rotor 16 begins to open the first flow hole 121, 821, which has been entirely closed. Furthermore, a rotational angle ag2 shown in FIG. 12 and FIG. 13 is a rotational angle of the rotor 16 when the opening degree of the first flow hole 121, 821 reaches the maximum opening degree.

In contrast, according to the present embodiment, as described above, the one-side hole edge 121a of the first flow hole 121 extends in the valve radial direction Dr along the imaginary second radial line L2r shown in FIG. 7, and the first hole closing portion edge 161a extends in the valve radial direction L1r along the first radial line L1r shown in FIG. 6. In the view taken in the valve axial direction Da, both of the first radial line L1r and the second radial line L2r pass through the valve axis Cv.

Therefore, according to the present embodiment, in response to the rotation of the rotor 16, for example, when the first hole closing portion edge 161a is placed in the position, in which the first hole closing portion edge 161a overlaps with the one-side hole edge 121a of the first flow hole 121 on the other side of the one-side hole edge 121a in the valve axial direction Da, the first hole closing portion edge 161a is placed in the following orientation. That is, in the view taken in the valve axial direction Da shown in FIG. 6, the first hole closing portion edge 161a is placed in the orientation, in which the first hole closing portion edge 161a extends along the one-side hole edge 121a of the first flow hole 121, as indicated by a dot-dot-dash line LG. That is, the first hole closing portion edge 161a is placed in the orientation, in which the first hole closing portion edge 161a coincides with the one-side hole edge 121a of the first flow hole 121.

Therefore, in the case where a size of an opened portion 121 h of the first flow hole 121 is increased or decreased by a minute opening degree of the first flow hole 121, the size of the opened portion 121h is increased or decreased in the valve circumferential direction Dc but is not increased or decreased in the valve radial direction L1r in response to the rotation of the rotor 16.

Therefore, in the present embodiment, in the case where the rotor 16 is rotated toward the other side in the valve circumferential direction Dc as indicated by the arrow A1, the size of the opening area of the first flow hole 121 changes relative to the rotational angle of the rotor 16 as shown in FIG. 13. That is, as encircled by a dot-dot-dash line Cx in FIG. 13, even at the minute opening degree during the beginning of the opening of the first flow hole 121, the relationship between the size of the opening area of the first flow hole 121 and the rotational angle of the rotor 16 is linear. In other words, the size of the opening area of the first flow hole 121 linearly changes relative to the rotational angle of the rotor 16 from the begging of the opening of the first flow hole 121 in the case where the first flow hole 121 is opened in response to the rotation of the rotor 16.

The above relationship, in which the size of the opening area of the first flow hole 121 linearly changes relative to the rotational angle, is, in other words, a relationship where the size of the opening area of the first flow hole 121 changes as a linear function of the rotational angle. Furthermore, in the view taken in the valve axial direction Da, the opening area of the first flow hole 821 is an area of the opened portion (i.e., the opened portion 121h of FIG. 6) of the first flow hole 121, which is opened by the first hole closing portion 161.

Furthermore, according to the present embodiment, in the case where the rotor 16 is rotated toward the one side in the valve circumferential direction Dc to open the second flow hole 122, a relationship between the size of the opening area of the second flow hole 122 and the rotational angle of the rotor 16 is the same as the above-described relationship between the size of the opening area of the first flow hole 121 and the rotational angle of the rotor 16. That is, in the case where the second flow hole 122 is opened, the size of the opening area of the second flow hole 122 linearly changes relative to the rotational angle of the rotor 16 from the begging of the opening of the first flow hole 121 in the case where the first flow hole 121 is opened in response to the rotation of the rotor 16.

As described above, according to the present embodiment, as shown in FIG. 6, the one-side hole edge 121a of the first flow hole 121 is progressively spaced from the inter-hole center line LFr and thereby progressively increases the distance between the one-side hole edge 121a and the inter-hole center line LFr toward the outer side in the valve radial direction Dr. Therefore, according to the present embodiment, the following can be said in comparison with, for example, the case where the one-side hole edge 821a is parallel to the inter-hole center line LFr as in the comparative example shown in FIG. 11. That is, when the rotor 16 is rotated as indicated by the arrow Al to begin the opening of the first flow hole 121 which has been entirely closed, the one-side hole edge 121a is placed in or close to the orientation, in which one-side hole edge 121a extends along the first hole closing portion edge 161a in the view taken in the valve axial direction Da. Therefore, since the opening area of the first flow hole 121 changes in a nearly linear or linear manner from the beginning of the opening of the first flow hole 121 relative to the rotational angle of the rotor 16, it is possible to improve the controllability in the control of the minute flow rate of the coolant passing through the first flow hole 121. This makes it easy to achieve the high-precision flow rate control of the coolant.

Furthermore, according to the present embodiment, as shown in FIGS. 6 and 13, the size of the opening area of the first flow hole 121 linearly changes relative to the rotational angle of the rotor 16 from the begging of the opening of the first flow hole 121 in the case where the first flow hole 121 is opened in response to the rotation of the rotor 16. Therefore, in comparison to the case, in which the size of the opening area of the first flow hole 821 of the comparative example changes in a non-linear manner from the beginning of the opening of the first flow hole 821 relative to the rotational angle of the rotor 16 as shown in FIG. 12, it is possible to improve the controllability in the control of the minute flow rate of the coolant passing through the first flow hole 121. This makes it easy to achieve the high-precision flow rate control of the coolant.

Furthermore, according to the present embodiment, as shown in FIG. 6, the first hole closing portion edge 161a extends in the valve radial direction L1r along the imaginary first radial line L1r which linearly extends from the valve axis Cv in the valve radial direction Dr. Furthermore, as shown in FIG. 7, the one-side hole edge 121a of the first flow hole 121 extends in the valve radial direction L1r along the imaginary second radial line L2r which linearly extends from the valve axis Cv in the valve radial direction Dr. Therefore, with the simple structure, it is possible to realize the configuration, in which the relationship between the size of the opening area of the first flow hole 121 and the rotational angle of the rotor 16 becomes linear from the begging of the opening of the first flow hole 121.

Furthermore, according to the present embodiment, as shown in FIGS. 4 and 5, the contact end part 115a of the outlet-side partition 115 contacts the flow hole partition 123 of the stator 12. The flow hole partition 123 has the widened part that has the width which is measured in the valve circumferential direction Dc and is larger than the width of the contact end part 115a measured in the valve circumferential direction Dc. Therefore, even when the position of the stator 12 slightly deviates relative to the outlet-side partition 115, a seal width, which is obtained through the contact of the contact end part 115a to the flow hole partition 123, is not likely to decrease. Therefore, the leakage of the coolant, which flows between the contact end part 115a and the flow hole partition 123, can be easily limited.

Another advantage is that a decrease in the size of the opening area of the first flow hole 121 or the second flow hole 122, which would be result from misalignment between the stator 12 and the outlet-side partition 115, can be easily limited.

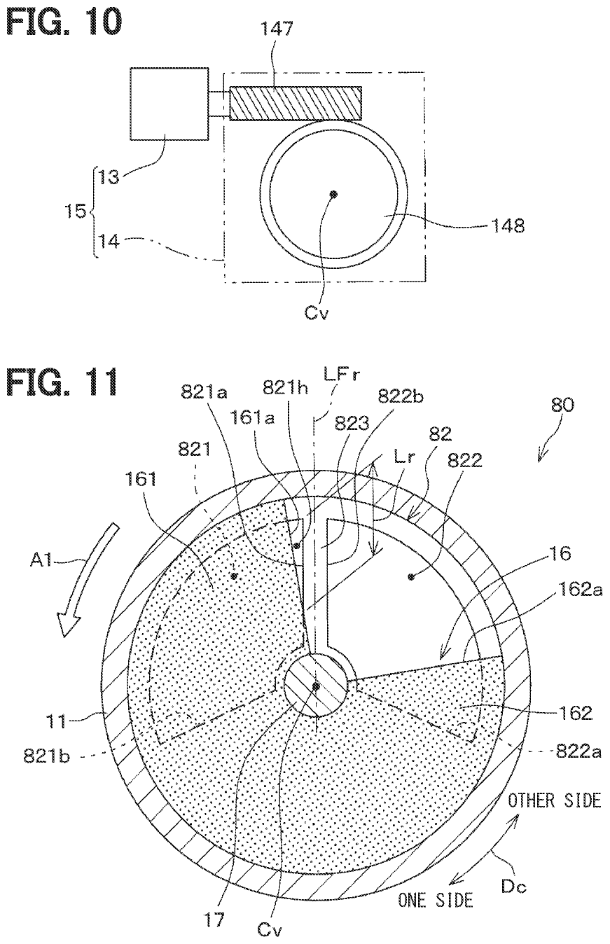

According to the present embodiment, as shown in FIGS. 9 and 10, the worm 147, which serves as a drive-side gear, is configured to limit the transmission of the rotational force from the worm wheel 148, which serves as a driven-side gear, to the electric motor 13. Therefore, it is possible to achieve the holding of the rotor 16 in the deenergized state where the rotational position of the rotor 16 is maintained without energizing the electric motor 13. With this holding in the deenergized state, It is possible to reduce the electric power consumption.

In addition, since the gear mechanism 14 of the present embodiment is the worm gear mechanism, the number of components can be reduced in comparison to a case where a structure other than the worm gear mechanism is adopted as the structure for realizing the holding in the deenergized state described above. As a result, it is easy to simplify the structure and manufacture of the gear mechanism 14.

Furthermore, a high reduction ratio is obtained in the gear mechanism 14, and it is easy to increase the locking force that limits the transmission of the rotational force from the rotor 16 to the electric motor 13.

### Second Embodiment

Next, a second embodiment will be described. In the present embodiment, points, which are different from the first embodiment, will be mainly described. Furthermore, the description of the same or equivalent portions as those in the aforementioned embodiment will be omitted or simplified. This is also true in the description of the later embodiments.

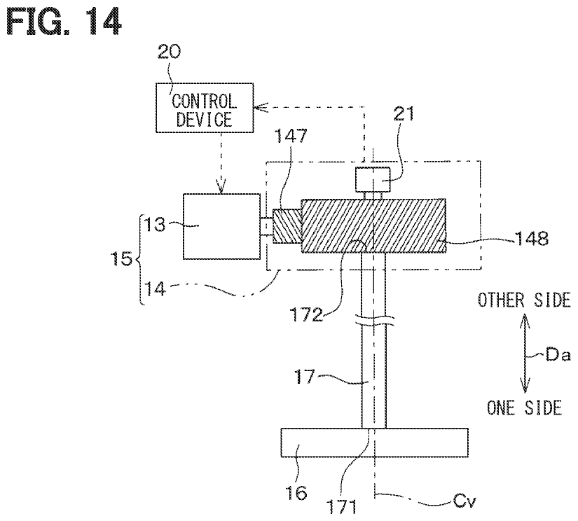

As shown in FIG. 14, the electric motor 13 of the present embodiment is not the stepping motor but is, for example, a direct current (DC) motor. Furthermore, the valve device 10 includes an angle sensing mechanism 21.

The angle sensing mechanism 21 is an angle sensor which is configured to sense a rotational angle of the valve rotatable shaft 17 and is coupled to the valve rotatable shaft 17. A measurement signal, which indicates the rotational angle of the valve rotatable shaft 17 (in other words, a rotational position of the rotor 16), is transmitted from the angle sensing mechanism 21 to the control device 20.

The control device 20 senses the rotational position of the rotor 16 through the angle sensing mechanism 21 and controls the rotational angle of the electric motor 13 through feedback of the sensed result. By performing such a control operation, the rotational position control of the rotor 16, which limits overshoot, can be performed.

The rest of the present embodiment, which is other than the above-described points, is the same as that of the first embodiment. Furthermore, in the present embodiment, the advantages, which are achieved by the common configuration that is common to the first embodiment described above, can be obtained in the same manner as in the first embodiment.

### Third Embodiment

Next, a third embodiment will be described. In the present embodiment, points, which are different from the first embodiment, will be mainly described.

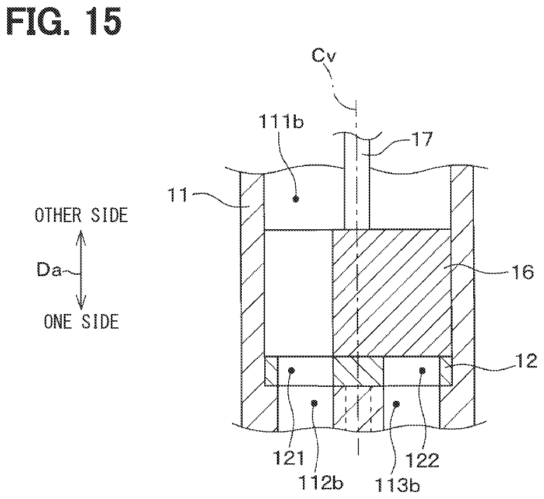

As shown in FIG. 15, in the present embodiment, the rotor 16 is not shaped in the form of the circular disk having the cutout 16a. With reference to FIGS. 6 and 15, the rotor 16 of the present embodiment is shaped in a form of a cylinder which is centered on the valve axis Cv and has the cutout 16a.

The rest of the present embodiment, which is other than the above-described points, is the same as that of the first embodiment. Furthermore, in the present embodiment, the advantages, which are achieved by the common configuration that is common to the first embodiment described above, can be obtained in the same manner as in the first embodiment.

Although the present embodiment is a modification based on the first embodiment, it is possible to combine the present embodiment with the aforementioned second embodiment.

### Other Embodiments

(1) In each of the above embodiments, the fluid, which flows through the valve device 10, is the coolant. Alternatively, the fluid may be another type of fluid that is other than the coolant. Furthermore, the fluid, which flows through the valve device 10 may be gas rather than the liquid.

(2) In each of the above embodiments, the valve device 10 is installed to, for example, the hybrid vehicle. However, the application of the valve device 10 is not limited to the vehicle.

(3) In each of the above embodiments, for example, as shown in FIG. 3, the drive source, which rotates the rotor 16, is the electric motor 13. However, the drive source needs not be powered by the electric current and may be another type of rotating device that is other than the electric motor.

(4) In each of the above embodiments, the rotor 16 and the stator 12 shown in FIG. 3 are both made of the resin. Alternatively, for example, one or both of the rotor 16 and the stator 12 may be made of ceramic.

In the case where the one or both of the rotor 16 and the stator 12 are made of the ceramic, since the ceramic is a low-friction material, the frictional resistance of the rotor 16 against the stator 12 can be stabilized.

(5) In each of the above embodiments, as shown in FIG. 3, the housing 11 and the stator 12 are respectively formed as separate components. However, this is only one example. For example, the housing 11 and the stator 12 may be made as a single molded component that is formed integrally in one-piece.

(6) In the first embodiment, as shown in FIGS. 2 and 3, the valve device 10 is the three-way valve. Alternatively, the valve device 10 may be a two-way valve, a four-way valve or a five-way valve.

(7) In the first embodiment, as shown in FIG. 9, the valve device 10 has the gear mechanism 14. Alternatively, the gear mechanism 14 may be eliminated.

(8) In each of the above embodiments, as shown in FIG. 6, the rotor 16 has the cutout 16a, which is shaped in the V-shape. However, the cutout 16a may be replaced by a through-hole that extends through the rotor 16 in the valve axial direction Da.

(9) In each of the above embodiments, as shown in FIGS. 6 and 7, each of the one-side hole edge 121a and the other-side hole edge 121b of the first flow hole 121 extends along the corresponding radial line L2r, LCr that extends from the valve axis Cv. However, this is only one example. This is also true for the one-side hole edge 122a and the other-side hole edge 122b of the second flow hole 122 and the first hole closing portion edge 161a and the second hole closing portion edge 162a of the rotor 16.

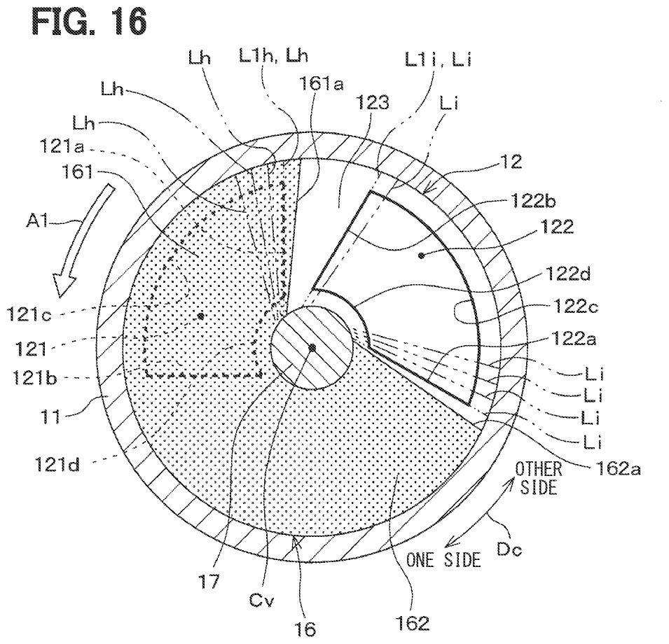

For example, the one-side hole edge 121a and the other-side hole edge 121b of the first flow hole 121, the one-side hole edge 122a and the other-side hole edge 122b of the second flow hole 122, and the first hole closing portion edge 161a and the second hole closing portion edge 162a of the rotor 16 may be formed as indicated in FIG. 16 that corresponds to FIG. 6. Even in the example of FIG. 16, the size of the opening area of the first flow hole 121 linearly changes relative to the rotational angle of the rotor 16 from the begging of the opening of the first flow hole 121 in the case where the first flow hole 121 is opened in response to the rotation of the rotor 16.

Specifically, in the example shown in FIG. 16, each of the one-side hole edge 121a and the other-side hole edge 121b of the first flow hole 121 and the one-side hole edge 122a and the other-side hole edge 122b of the second flow hole 122 does not extend along a radial line that extends linearly from the valve axis Cv in the valve radial direction Dr. Also, each of the first hole closing portion edge 161a and the second hole closing portion edge 162a of the rotor 16 does not extend along a radial line that extends linearly from the valve axis Cv in the valve radial direction Dr.

However, in the example shown in FIG. 16, in response to the rotation of the rotor 16, for example, when the first hole closing portion edge 161a is placed in the position, in which the first hole closing portion edge 161a overlaps with the one-side hole edge 121a of the first flow hole 121 on the other side of the one-side hole edge 121a in the valve axial direction Da, the first hole closing portion edge 161a is placed in the following orientation. That is, in the view taken in the valve axial direction Da shown in FIG. 16, the first hole closing portion edge 161a is placed in an orientation, in which the first hole closing portion edge 161a extends along the one-side hole edge 121a of the first flow hole 121, as indicated by a dot-dot-dash line L1h. This is also true for the relationship between the other-side hole edge 122b of the second flow hole 122 and the second hole closing portion edge 162a of the rotor 16, as indicated by a dot-dot-dash line L1i.

Each dot-dot-dash line Lh shown in FIG. 16 indicates a corresponding orientation of the first hole closing portion edge 161a when the first hole closing portion edge 161a is rotated in response to the rotation of the rotor 16, and each dot-dot-dash line Li shown in FIG. 16 indicates a corresponding orientation of the second hole closing portion edge 162a when the second hole closing portion edge 162a is rotated in response to the rotation of the rotor 16.

(10) In each of the above embodiments, as shown in FIG. 7, the one-side hole edge 121a of the first flow hole 121 extends along the second radial line L2r. However, this is only one example. For example, although the one-side hole edge 121a of the first flow hole 121 is progressively spaced from the inter-hole center line LFr toward the other side in the valve circumferential direction Dc and thereby progressively increases the distance between the one-side hole edge 121a of the first flow hole 121 and the inter-hole center line LFr toward the outer side in the valve radial direction Dr, the one-side hole edge 121a of the first flow hole 121 may not extend along the second radial line L2r. This is also true for the other-side hole edge 122b of the second flow hole 122. For example, if the interval DWo shown in FIG. 7 is equal to or less than about 2-3 times the interval DWi, it is considered that the advantage of the first embodiment of improving the controllability in the controlling of the minute flow rate of the coolant passing through the first flow hole 121 can be obtained to some extent.

Also, in the view taken in the valve axial direction Da, it is considered good that a straight line, which is obtained by virtually extending the one-side hole edge 121a of the first flow hole 121, intersects with a straight line, which is obtained by virtually extending the inter-hole center line LFr, and an intersection point, at which these two straight lines intersect with each other, falls within a predetermined range. This prescribed range is a range which includes the valve axis Cv and extends from the valve axis Cv toward the opposite side that is opposite to the flow hole partition 123. Specifically, in the case of FIG. 7, this predetermined range is a range that includes the valve axis Cv and extends from the valve axis Cv toward the lower side of the plane of FIG. 7.

(11) In each of the above embodiments, as shown in FIG. 7, each corner, at which corresponding two of the hole edges 121 a, 121b, 121c, 121d of the first flow hole 121 are connected to each other, is not rounded. Alternatively, each corner, at which corresponding two of the hole edges 121a, 121b, 121c, 121d of the first flow hole 121 are connected to each other, may be rounded. This is also true for the second flow hole 122.

(12) The present disclosure is not limited to the above-described embodiments and may be implemented in various variations. Further, the above embodiments are not unrelated to each other and can be appropriately combined unless the combination is clearly impossible.

Needless to say, in each of the above-described embodiments, the elements of the embodiment are not necessarily essential except when it is clearly indicated that they are essential and when they are clearly considered to be essential in principle. In each of the above embodiments, when a numerical value such as the number, numerical value, amount, range or the like of the constituent elements of the embodiment is mentioned, the present disclosure should not be limited to such a numerical value unless it is clearly stated that it is essential and/or it is required in principle.

In each of the above embodiments, when the material, the shape, the positional relationship or the like of the constituent elements of the embodiment is mentioned, the present disclosure should not be limited the material, the shape, the positional relationship or the like unless it is clearly stated that it is essential and/or it is required in principle.

What is claimed is:

1. A valve device configured to conduct fluid, comprising:
a rotor that is configured to rotate about a predetermined axis; and
a flow hole formation portion that is located on one side of the rotor in an axial direction of the predetermined axis and has:
a first flow hole which extends through the flow hole formation portion in the axial direction, wherein the first flow hole is configured to be opened and closed by the rotor and conduct the fluid through the first flow hole in an open state where the first flow hole is opened; and
a second flow hole which extends through the flow hole formation portion in the axial direction and is located adjacent to the first flow hole on one side of the first flow hole in a circumferential direction of the predetermined axis, wherein the second flow hole is configured to be opened and closed by the rotor and conduct the fluid through the second flow hole in an open state where the second flow hole is opened, wherein:
the rotor has a hole closing portion that is configured to increase or decrease a covered area of the first flow hole, which is covered by the hole closing portion, in response to rotation of the rotor;
the hole closing portion has a hole closing portion edge which extends in a radial direction of the predetermined axis and is located at a circumferential end of the hole closing portion on the one side in the circumferential direction, wherein in a state where the first flow hole is entirely closed by the hole closing portion, when the rotor is rotated toward another side, which is opposite to the one side in the circumferential direction, the hole closing portion begins to open the first flow hole;
the first flow hole has a one-side hole edge which is located at a circumferential end of the first flow hole on the one side in the circumferential direction and extends in the radial direction;
the second flow hole has an other-side hole edge which is located at a circumferential end of the second flow hole on the another side in the circumferential direction and extends in the radial direction;
in a view taken in the axial direction, the one-side hole edge and the other-side hole edge are symmetric to each other with respect to an imaginary inter-hole center line that extends in the radial direction from the predetermined axis and passes through a center that is centered between the one-side hole edge and the other-side hole edge; and
the one-side hole edge is progressively spaced from the imaginary inter-hole center line and thereby progressively increases a distance between the one-side hole edge and the imaginary inter-hole center line toward an outer side in the radial direction.

2. The valve device according to claim 1, wherein:
the hole closing portion edge extends in the radial direction along an imaginary first radial line which extends from the predetermined axis in the radial direction; and
the one-side hole edge of the first flow hole extends in the radial direction along an imaginary second radial line which extends from the predetermined axis in the radial direction.

3. A valve device configured to conduct fluid, comprising:
a rotor that is configured to rotate about a predetermined axis; and
a flow hole formation portion that is located on one side of the rotor in an axial direction of the predetermined axis and has a flow hole which extends through the flow hole formation portion in the axial direction, wherein the flow hole is configured to be opened and closed by the rotor and conduct the fluid through the flow hole in an open state where the flow hole is opened, wherein:
the rotor has a hole closing portion that is configured to increase or decrease a covered area of the flow hole, which is covered by the hole closing portion, in response to rotation of the rotor; and
in a view taken in the axial direction, a size of an opening area of an opened portion of the flow hole, which is opened by the hole closing portion, linearly changes in response to a change in a rotational angle of the rotor when the hole closing portion begins to open the flow hole from a state where the flow hole is entirely closed by the hole closing portion.

4. The valve device according to claim 3, wherein:
the hole closing portion has a hole closing portion edge that extends in a radial direction of the predetermined axis along an imaginary first radial line which extends from the predetermined axis in the radial direction while the hole closing portion edge is located at a circumferential end of the hole closing portion on one side in a circumferential direction of the predetermined axis, wherein in a state where the flow hole is entirely closed by the hole closing portion, when the rotor is rotated toward another side, which is opposite to the one side in the circumferential direction, the hole closing portion begins to open the flow hole;
the flow hole has a one-side hole edge which is located at a circumferential end of the flow hole on the one side in the circumferential direction; and
the one-side hole edge extends in the radial direction along an imaginary second radial line which extends from the predetermined axis in the radial direction.

5. The valve device according to claim 4, comprising a partition wall that is located on the one side of the flow hole formation portion in the axial direction, wherein:
the flow hole is a first flow hole, and the flow hole formation portion has a second flow hole which extends through the flow hole formation portion in the axial direction and is located adjacent to the first flow hole on the one side of the first flow hole in the circumferential direction, wherein the second flow hole is configured to be opened and closed by the rotor and conduct the fluid through the second flow hole in an open state where the second flow hole is opened;
the flow hole formation portion has a flow hole partition that partitions between the first flow hole and the second flow hole and forms the one-side hole edge;
the partition wall partitions between: a first communication chamber which is communicated with the first flow hole; and a second communication chamber which is communicated with the second flow hole, and the partition wall has a contact end part which contacts the flow hole partition and is formed at an end of the partition wall on another side which is opposite to the one side in the axial direction; and
the flow hole partition has a widened part that has a width which is measured in the circumferential direction and is larger than a width of the contact end part measured in the circumferential direction.
